(19) United States
(12) Patent Application Publication
(10) Pub. No.: US 2002/0075295 A1
(43) Pub. Date: Jun. 20, 2002

(54) Telepresence using panoramic imaging and directional sound

(76) Inventors: Anthony Joseph Stentz, Pittsburgh, PA (US); Sanjiv Singh, Pittsburgh, PA (US); Herman Herman, Pittsburgh, PA (US)

Correspondence Address: Alan G. Towner, Eckert Seamans Cherin & Mellott, LLC, 44th Floor, 600 Grant Street, Pittsburgh, PA, 15219, US

(21) Appl. No.: 09/778,682

(22) Filed: Feb. 7, 2001

Related U.S. Application Data
(60) Provisional application No. 60/180,620, filed on Feb. 7, 2000.

(51) Int. Cl. G09G 5/00

(52) U.S. Cl. 345/727

(57) ABSTRACT

The present invention relates to the capture and playback of directional sound in conjunction with selected panoramic visual images to produce an immersive experience.

### CROSS-REFERENCE TO RELATED APPLICATION

This application claims the benefit of U.S. Provisional Patent Application Ser. No. 60/180,620 filed Feb. 7, 2000.

### FIELD OF THE INVENTION

The present invention relates to panoramic imaging, and more particularly relates to the use of panoramic visual images in combination with directional sound to provide an emersive imaging experience.

### BACKGROUND INFORMATION

Panoramic imagery is able to capture a large azimuth view with a significant elevation angle. In some cases, the view is achieved through the use of wide angle optics such as fish-eye lenses. In other cases, it is achieved through the use of a combination of mirrors and lenses. Alternatively, the view may be developed by rotating an imaging sensor so as to achieve a panorama. The panoramic view can be composed of still images or, in cases where the images are taken at high frequencies, the sequence can be interpreted as animation. Wide angles associated with panoramic imagery can cause the image to appear warped, i.e., the image does not correspond to a natural human view. This imagery can be unwarped by various means including software to display a natural view.

U.S. Pat. No. 5,771,041 to Small discloses a system for producing directional sound in computer-based virtual environments. This reference describes how sounds can be played back as opposed to how they are collected. Moreover, these sounds are recorded only as point sources and no provision is available for directional capture of sound or capture of diffuse sounds.

While systems have been proposed in which panoramic images can be created in computer generated environments, such as with three dimensional models, the present invention relates to photographed still or video imagery that is combined with directional sound to provide telepresence.

### SUMMARY OF THE INVENTION

Visual images and sound are very important to provide a complete sense of place. The present telepresence system conveys not only visual information but also audio information to improve the realism of the experience.

An aspect of the present invention is to provide an imaging system comprising a panoramic visual images display, and an associated directional sound playback device.

Another aspect of the present invention is to provide an imaging system and method for providing a panoramic visual images, and for providing directional sound associated with the panoramic visual images.

A further aspect of the present invention is to provide an image recording system comprising a panoramic visual images recording device, and an associated directional sound capturing device.

Another aspect of the present invention is to provide an image recording system and method for capturing panoramic visual images, and for capturing directional sound associated with the panoramic visual images.

A further aspect of the present invention is to provide an image recording and playback system comprising a panoramic visual images recording device, an associated directional sound capturing device, a panoramic visual images display, and an associated directional sound playback device.

Another aspect of the present invention is to provide an image recording and playback system and method for capturing panoramic visual images, for capturing directional sound associated with the panoramic visual images, for providing panoramic visual images, and for providing directional sound associated with the panoramic visual images.

These and other aspects of the present invention will be more apparent from the following description.

### BRIEF DESCRIPTION OF THE DRAWINGS

FIG. 1 is a schematic diagram illustrating a system for producing panoramic images.

FIG. 2 is a raw image from a panospheric camera.

FIG. 3 is the image from FIG. 2 displayed as a rectangular image using a projection onto a cylindrical surface.

FIG. 4 is a schematic illustration of a single panoramic camera with multiple microphones which are used to record sound from one or more sound sources.

FIG. 5 schematically illustrates how the loudness of a sound from a particular sound source depends upon its location with respect to the current viewing direction.

FIG. 6 is the rectangular projected image of FIG. 3, illustrating an angle between the viewing direction (the center of the selected view) and the reference frame of the camera.

FIG. 7 schematically illustrates sound that is recreated when microphones are not at the optical center of a panoramic device.

FIG. 8 schematically illustrates multiple panoramic cameras in combination with multiple microphones which are used to record sound from one or more sound sources.

### DETAILED DESCRIPTION

The present invention combines panoramic visual images and directional sound. The panoramic visual images can comprise one or more individual still images, or a sequence of images such as a video stream. An aspect of the invention is that sound recorded with more than one recording device can be played back in conjunction with panoramic images based on a particular viewing direction. Upon playback, directional sound associated with the particular view convey a life-like experience.

As used herein, the term “panoramic visual images” means wide angle images taken from a field of view of from about 60° to 360°, typically from about 90° to 360°. Preferably, the panoramic visual images comprise a field of view of from about 180° to 360°. In a particular embodiment, the field of view is up to 360° in a principal axis, which is often oriented to provide a 360° horizontal field of view. In this embodiment, a secondary axis may be defined, e.g., a vertical field of view. Such a vertical field of view may typically range from 0.1° to 180°, for example, from 1° to 170°. In accordance with the present invention, sections of the panoramic visual images may be selectively viewed. For example, while the panoramic visual images may comprise up to a 360° field of view, a smaller section may be selectively displayed, e.g., a field of from about 1° to about 60° may be selectively viewed.

As used herein, the term “directional sound” means the sound captured or reproduced to a listener as a function of a viewing direction selected from the panoramic visual images. In this manner, the directional sound is associated with the panoramic visual images. Preferably, the orientation of the directional sound corresponds with the viewing angle or selected section from the panoramic visual images. For example, multiple sound recording devices may be used to provide a virtual microphone during playback that can be pointed in the same direction as a virtual camera from selected panoramic data. In one embodiment, an estimate of distance between the camera and the sound source, e.g., either from processing the sound received at the camera or from an external source, can be used to co-locate sound with video at a point in space, rather than in just a particular direction.

An embodiment of the present invention provides an imaging system including a panoramic visual images display and a directional sound playback device. Examples of panoramic visual images displays include various types of computer monitors, televisions, video projection systems, head mounted displays, holograms and the like. The panoramic visual images display may comprise a single display device, or multiple display devices such as a row or array of devices. Examples of directional sound playback devices include one or more speakers driven by any suitable power source such as one or more amplifiers.

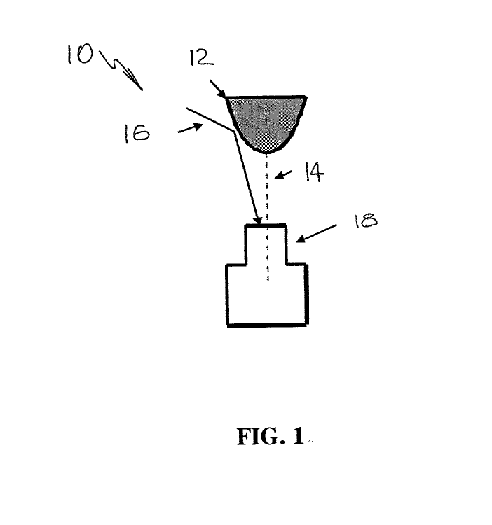

FIG. 1 is a schematic diagram illustrating a system 10 for producing panoramic images. A mirror 12 having an optical axis 14 gathers light 16 from all directions and redirects it to a camera 18. Visually, the immersive experience may be produced using a prerecorded or live sequence of images (possibly at TV frame rate but also at much slower frequencies) that are panoramic. A camera and panoramic mirror arrangement as shown in FIG. 1, or any other suitable panoramic imaging device, may be used to capture the panoramic visual images.

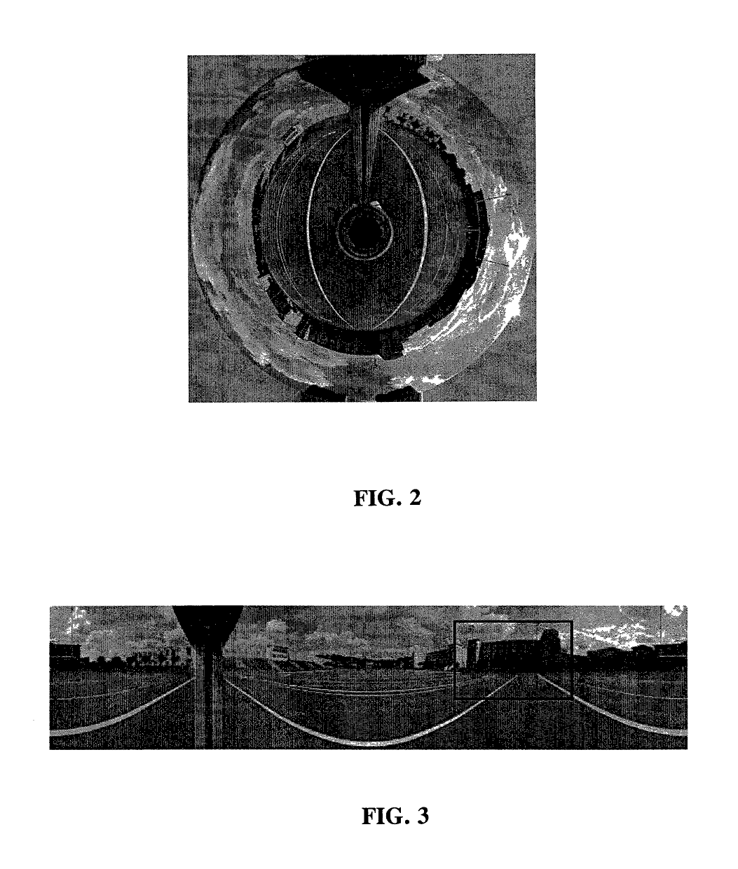

FIG. 2 is a raw image from a panospheric camera. FIG. 3 is the image from FIG. 2 displayed as a rectangular image using a projection onto a cylindrical surface. A viewer can select any part of this image to examine, e.g., as shown in the framed region. Each panoramic image may display a full 360° view from a point or a set of points. These images may be produced by any suitable type of panoramic camera, and may be viewed using any suitable projection (perspective, cylindrical, spherical, etc.) on a display device such as TV screens, computer monitors, head mounted displays and the like. At any given time, only part of the image may be displayed to the user, based on commands given to the system.

In addition to panoramic imagery, sound may be recorded simultaneously. Sound may be captured on at least two channels and a temporal and spatial correspondence may be established between the panoramic images and the sound. Sound can be captured, for example, by any number of microphones each of which might be substantially uni-directional (only capture sound within a cone) or omni-directional (captures sound from all directions). Omni-directional microphones may be approximated by the use of several directional microphones placed in a ring. Sound may also be recorded separately, and an artificial coupling may be made between the panorama and the sound. It is also possible that either the panorama or the sound are synthetic, or both. That is, artificial panoramas created by computer models can be used in place of real panoramas and artificial sources of sound such as generated by a computer can be used, or a different sound that has been recorded separately may be associated with the video.

The sources of sound may be point sources (e.g., a singer on a stage) or a diffuse source (e.g., an applauding audience). The spatial correspondence between the panoramic images and sound can be achieved by localizing of the sources of the sound and embedding that information in the data stream that contains both the panoramic images and sound. The method for the localization of the sources of the sound may include measuring both the loudness and phase of the sound. From these measurements, an estimate of the location of the sources can be computed. If the panoramic images are generated using a rotating device, one rotating microphone can also be used to simulate two or more microphones.

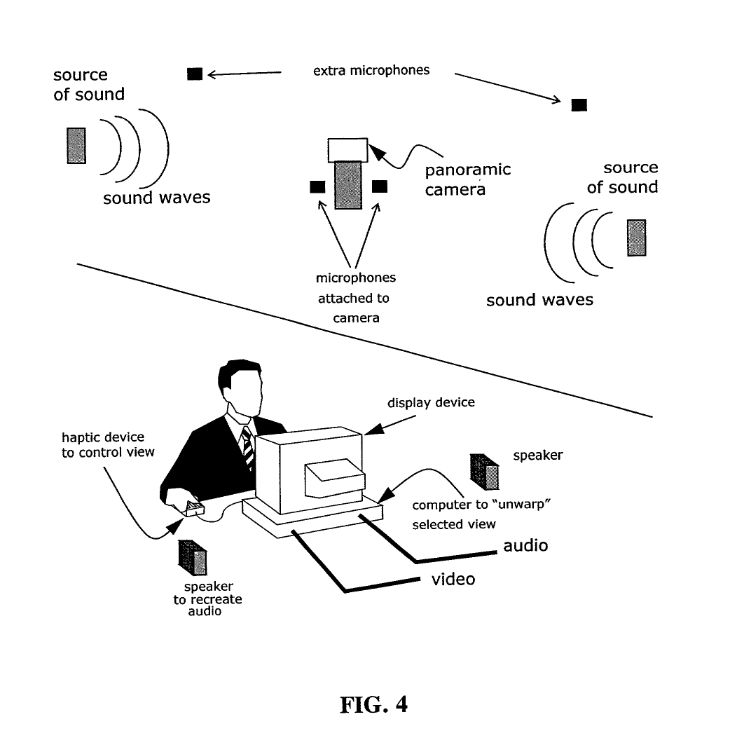

In one embodiment of the invention as schematically illustrated in FIG. 4, a single panoramic camera is coupled with two or more microphones. The microphones may be located adjacent the camera, or may be located remotely from the camera. The audio recordings of the microphones may be synchronized with the video imagery. As the camera collects panoramic images, the sound is also captured by the microphones and the location of the source of the sound is computed. As the view is changed by the user manipulating a haptic device such as joystick, the audio playback is altered such that the user is able to perceive the direction of the source of sound.

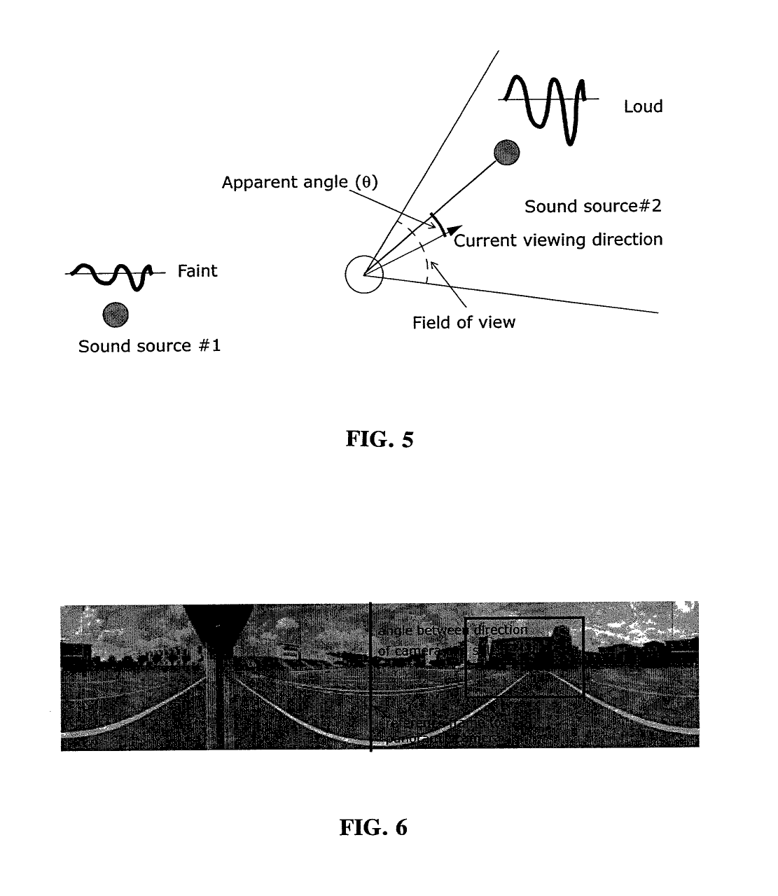

FIG. 5 schematically illustrates how the loudness of a sound from a particular sound source depends upon its location with respect to the current viewing direction. The sound at the upper right of FIG. 5 appears to come slightly from the left given the viewing direction shown. As the viewing direction changes, the strength of the sound can be made to vary as a function of angle between the viewing direction and the direction to the source of the sound. For the apparent angle θ, one such function may be cos(θ/2).

If the source of the sound remains constant, the user is able to sense the unvarying direction of the sound as the viewing direction is changed. Alternately, if the direction to the source of sound is changing, the user is able to sense the direction to the moving source as the selected view of the panoramic imagery is changed. One or more speakers can be used to playback the sound. If there is only one speaker, the loudness of the sound may be modulated according to the alignment of the sound source with respect to the current viewing angle. If multiple speakers are used for playback, the sound played back from the speakers may be modulated so as to provide the listener with the feedback.

FIG. 6 is the rectangular projected image of FIG. 3, illustrating an angle between the viewing direction (the center of the selected view) and the reference frame of the camera. Each row of the image spans 180°. If the viewing direction points to the location of the sound source, then the sound will be at its loudest. On the other hand, if the sound originates 180° from the viewing direction, the sound will be at its faintest.

If there is more than one speaker, the phase and loudness of the sound on those speakers may be modulated to emulate the position of the sound source with respect to the current viewing direction. Although there may be no depth information from the camera, the amount of zoom selected by the user could be interpreted as a depth cue to select the sound balance between the two microphones. It can also be used to alter the loudness of the sound so as to correspond with the experience of getting closer or farther away from the source of the sound. Thus, sound may be recreated as coming from a direction without knowing its exact position.

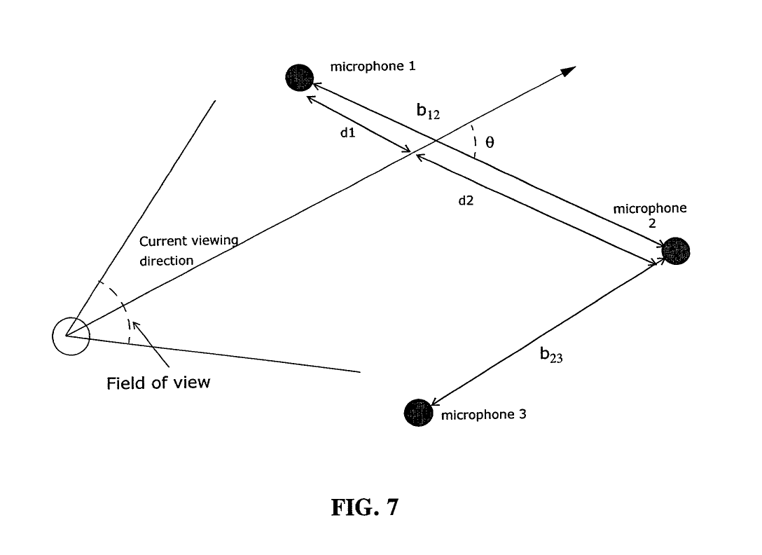

If the directional microphones are not at the optical center of the panoramic device, using the angular difference between the viewing direction and the microphone direction may not be sufficient. For example, three omni-directional microphones may be placed in an environment as illustrated in FIG. 7. A listening distance may be recreated by modulating the sound from the two microphones as a function of the angular difference between the viewing direction and the axis of the microphone baseline. In FIG. 7, b₁₂ is the baseline distance between microphones 1 and 2, while b₂₃ is the distance between microphones 2 and 3. The angle θ is the angle between the baseline and the viewing direction.

Only those microphones that fall in the field of view may be used to recreate the sound. In the embodiment shown in FIG. 7, microphones 1 and 2 are used while microphone 3 is not used. If the field of view were to rotate clockwise, microphone 1 would not be used but microphones 2 and 3 would be used. The sound is composed based on combinations of the sound recorded at two microphones. This may be done for every pair of microphones in the viewing area. The strengths of the sounds from the microphones may be combined as follows. The relative strength of the signal of microphone i is given by:

$$\frac{{b}_{ij} - {d}_{i}}{{b}_{ij}}$$

where bᵢⱼ is the baseline between microphones i and j and dᵢ is the distance between microphone i and the intersection of the axis of the viewing direction and bᵢⱼ. The effect of direction (the offset θ) may be computed as illustrated in FIG. 5.

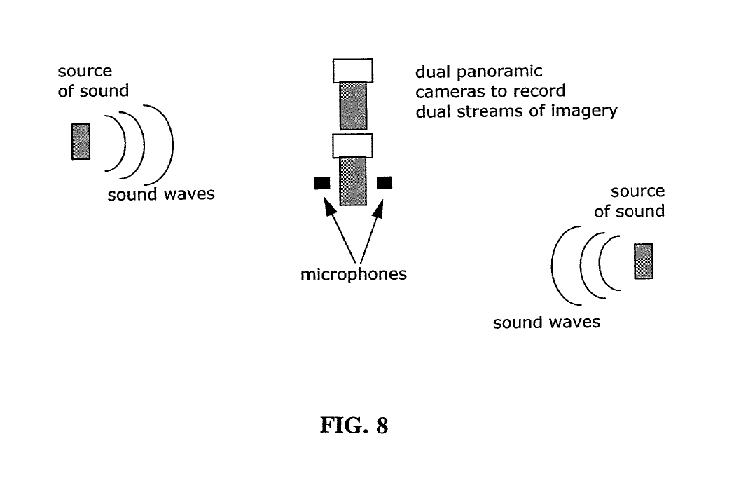

In another embodiment of the invention shown in FIG. 8, two simultaneously recorded sequences of panoramic imagery may be played back such that the user is able to perceive depth in the selected view in addition to the sound as in the previous embodiment. The depth may be either directly inferred by the user viewing the multiple image streams, or may be based on a 3D model that is extracted by a computer process that finds correspondence between features in the multiple views or tracks the image features in one or more image sequence to create the three dimensional model.

In a preferred embodiment of the invention, one panoramic camera may be used in conjunction with multiple microphones. The microphones have directionality, i.e., they are sensitive to sounds coming from the direction that they are pointed, with sensitivity falling off in other directions. The microphones may have overlapping fields of sensitivity. Any sound in the environment may be detected by at least two microphones. Sounds from the environment are recorded simultaneously with the video and can be correlated to the video for direct transmission or playback. The camera may have a natural frame of reference and sounds may be located either by position or direction (or both) with respect to the frame of reference. When the panoramic image is unwarped, the direction that the viewer chooses defines the offset from the camera reference frame. This offset may change dynamically with the selected view. The signal recorded from each microphone may be played back in a modified manner based on the offset from the camera reference frame. Sound from each microphone may be composed depending on the number of playback devices. If only one speaker is available, then the sounds recorded from all microphones may be simply added up.

If the offset between the direction of the microphone i and the camera reference is denoted by θᵢ, the strength of the signal associated with that microphone, Mᵢ, is cos(θᵢ)+ε, where ε is a minimal level of sound playback. The composite sound is created by:

Σ(cos(θᵢ)+ε)·Mᵢ

If the playback device consists of multiple speakers, the sound may be distributed to each speaker such that each speaker only plays the sounds corresponding to microphones pointed in a certain sector. For example, if four speakers are used, each speaker may only play sounds attributed to microphones in a 90 degree sector.

The present invention may be used for various telepresence applications that involve capturing of an event. Some examples of the possible applications include entertainment, surveillance and tourism.

Whereas particular embodiments of this invention have been described above for purposes of illustration, it will be evident to those skilled in the art that numerous variations of the details of the present invention may be made without departing from the invention as defined in the appended claims.

1. An imaging system comprising:
a panoramic visual images display device; and
an associated directional sound playback device.

2. The imaging system of claim 1, wherein the display device displays a selected portion of the panoramic visual images.

3. The imaging system of claim 2, wherein the selected portion of the panoramic visual images comprises a field of view of from about 1° to about 60°.

4. The imaging system of claim 2, wherein the directional sound playback device provides sound associated with the selected portion of the panoramic visual images.

5. An imaging system comprising:
means for providing panoramic visual images; and
means for providing directional sound associated with the panoramic visual images.

6. The imaging system of claim 5, wherein the means for providing panoramic visual images comprises a display device which displays a selected portion of the panoramic visual images.

7. The imaging system of claim 6 wherein the selected portion of the panoramic visual images comprises a field of view of from about 1° to about 60°.

8. The imaging system of claim 6 wherein the means for providing directional sound comprises a playback device which provides sound associated with the selected portion of the panoramic visual images.

9. A method of providing images comprising:
providing panoramic visual images; and
providing directional sound associated with the panoramic visual images.

10. An image recording system comprising:
a panoramic visual images recording device; and
an associated directional sound capturing device.

11. The image recording system of claim 10, wherein the panoramic visual images recording device records a field of view of from about 60° to 360°.

12. The image recording system of claim 10, wherein the panoramic visual images recording device records a field of view of from about 90° to 360°.

13. The image recording system of claim 10, wherein the panoramic visual images recording device records a field of view of from about 180° to 360°.

14. The image recording system of claim 10, wherein the panoramic visual images recording device comprises a camera.

15. The image recording system of claim 10, wherein the panoramic visual images recording device comprises a video camera.

16. The image recording system of claim 10, wherein the panoramic visual images recording device comprises a panoramic mirror.

17. The image recording system of claim 10, wherein the sound capturing device comprises at least two microphones.

18. The image recording system of claim 17, wherein the microphones are substantially omni-directional.

19. The image recording system of claim 17, wherein the microphones are substantially uni-directional.

20. An image recording system comprising:
means for capturing panoramic visual images; and
means for capturing directional sound associated with the panoramic visual images.

21. The image recording system of claim 20, wherein the panoramic visual images comprise a field of view of from about 60° to 360°.

22. The image recording system of claim 20, wherein the panoramic visual images recording device records a field of view of from about 60° to 90°.

23. The image recording system of claim 20, wherein the panoramic visual images recording device records a field of view of from about 60° to 180°.

24. The image recording system of claim 20, wherein the means for capturing directional sound comprises at least two microphones.

25. A method of recording images comprising:
capturing panoramic visual images; and
capturing directional sound associated with the panoramic visual images.

26. An image recording and playback system comprising:
a panoramic visual images recording device;
an associated directional sound capturing device;
a panoramic visual images display device; and
an associated directional sound playback device.

27. The image recording and playback system of claim 26, wherein the display device displays a selected portion of the panoramic visual images.

28. The image recording and playback system of claim 27, wherein the selected portion of the panoramic visual images comprises a field of view of from about 1° to about 60°.

29. The image recording and playback system of claim 27, wherein the directional sound playback device provides sound associated with the selected portion of the panoramic visual images.

30. The image recording and playback system of claim 26, wherein the panoramic visual images recording device records a field of view of from about 60° to 360°.

31. The image recording and playback system of claim 26, wherein the panoramic visual images recording device records a field of view of from about 90° to 360°.

32. The image recording and playback system of claim 26, wherein the panoramic visual images recording device records a field of view of from about 180° to 360°.

33. The image recording and playback system of claim 26, wherein the panoramic visual images recording device comprises a camera.

34. The image recording and playback system of claim 26, wherein the panoramic visual images recording device comprises a video camera.

35. The image recording and playback system of claim 26, wherein the panoramic visual images recording device comprises a panoramic mirror.

36. The image recording and playback system of claim 26, wherein the sound capturing device comprises at least two microphones.

37. The image recording and playback system of claim 36, wherein the microphones are substantially omni-directional.

38. The image recording and playback system of claim 36, wherein the microphones are substantially uni-directional.

39. An image recording and playback system comprising:
means for capturing panoramic visual images;
means for capturing directional sound associated with the panoramic visual images;
means for displaying a portion of the panoramic visual images; and
means for providing directional sound associated with the portion of the panoramic visual images.

40. A method of recording and providing images comprising:
capturing panoramic visual images;
capturing directional sound associated with the panoramic visual images;
displaying a portion of the panoramic visual images; and
providing directional sound associated with the portion of the panoramic visual images.
